(19) United States
(12) Patent Application Publication
(10) Pub. No.: US 2021/0010629 A1
(43) Pub. Date: Jan. 14, 2021

(54) VACUUM SOUNDPROOFING/INSULATING PANELS WITH VACUUM PUMP CONNECTOR ASSEMBLY AND METHOD AND SYSTEM FOR USING SAME TO PROVIDE ADJUSTABLE INSULATIVE EFFICIENCY TO A BUILDING ENVELOPE

(71) Applicant: Lawrence Everett Pierce, Hornby Island (CA)

(72) Inventor: Lawrence Everett Pierce, Hornby Island (CA)

(21) Appl. No.: 16/980,297

(22) PCT Filed: Jan. 7, 2019
(86) PCT No.: PCT/CA2019/050020

§ 371 Date: Sep. 11, 2020

Related U.S. Application Data
(60) Provisional application No. 62/641,605, filed on Mar. 12, 2018.

(51) Int. Cl. F16L 59/065; E04B 1/80

(52) U.S. Cl. CPC F16L 59/065; B32B 3/12; E04B 1/803

(57) ABSTRACT

A system of vacuum insulation panels provides an adjustable insulative resistance in a building envelope. The system includes a number of vacuum insulation panels installed to form separate insulation zones in the building envelope with airflow communication between selected vacuum insulation panels in a zone. A vacuum pump connects to vacuum pump connector assemblies of each vacuum insulation panel to thereby increase or decrease the amount of vacuum in each vacuum insulation panels. A digital processor controls the activation of the vacuum pump to adjust the insulative resistance of the building envelope. Thermostats provide real-time temperature information for each zone inside the building and for the outside temperature. Based on the temperature readings and other pre-programmed information the digital processor independently adjusts the isolative resistance of different zones of the building to maximize the heating and cooling efficiency.

### REFERENCE TO RELATED APPLICATIONS

The present application claims the benefits, under 35 U.S.C.§ 119(e), of U.S. Provisional Application Ser. No. 62/641,605 filed Mar. 12, 2018 entitled “Vacuum Soundproofing/Insulating Panels with Vacuum Pump Connector Assembly” which is incorporated herein by this reference.

### TECHNICAL FIELD

The present invention relates to insulating and soundproofing materials and panels for use in frame structures, cold storage appliances, roofs, floors and facades, soundproof rooms or similar applications, and in particular vacuum panels for such applications.

### BACKGROUND

In the past, insulation of wood frame structures, as well as metal frame, stone, brick and stucco structures, has been typically carried out using fiberglass batt insulation, and/or rigid panels of expanded or extruded foamed plastic and/or loose fill insulation of insulating fibres such as mineral wool. The insulation efficiency of such materials can only be increased by increasing the wall thickness. As a result of the increased emphasis on improving the energy efficiency of buildings, new measures have been introduced to provide better performance thermal insulation solutions. Such measures have included vacuum insulation panels.

A one-inch thick vacuum insulation panel can provide R50 insulation. It would require at least 12 inches of fiberglass to provide the same insulation value. However there are currently no products on the market using a vacuum for sound proofing. Sound travels at 343 meters per second in room temperature air, and cannot be transmitted through a vacuum. No vacuum product can provide 100% insulation or sound proofing because the product structure will transmit some heat/cold and/or sound, so the least enclosure for the vacuum is the most desirable.

Vacuum insulation panel products currently on the market are typically small panels, with a maximum size of about 20 square feet, and consist of a very porous rigid core sandwiched in between an outer covering such as layers of foil and/or plastic sheet, assembled in a vacuum environment. The outer covering is sealed at the edges, keeping the vacuum inside. Large equipment is required to assemble and seal these products, and they are expensive and non-repairable. That is, once the vacuum is lost due to puncture or leakage, the panel does not function. Major drawbacks for existing vacuum insulation panels products therefore include: size limitations, cost of production, fragility of the finished panels, cost to replace a damaged/leaking panel after installation, and uncertain lifespan of the vacuum charge.

There is therefore a need for a structure for robust vacuum insulation panels of various sizes which reduces cost of production and the cost to replace a damaged/leaking panel after installation, and increases the lifespan of the vacuum charge.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, apparatus and methods which are meant to be exemplary and illustrative, not limiting in scope. In various embodiments, one or more of the above-described problems have been reduced or eliminated, while other embodiments are directed to other improvements.

The disclosed embodiments provide improvements on existing vacuum panel construction, for use not only for heat insulation, but also sound proofing The disclosed vacuum panels are inexpensive to manufacture, rechargeable and repairable.

According to one embodiment a vacuum insulation panel and a vacuum pump connector assembly are provided. The vacuum pump connector assembly allows charging of the vacuum in the panels at the time of installation and refreshing of the vacuum charge at any time after installation, by activation of a vacuum pump. It may comprise three parts: an interface which may be installed in the panel at the time of manufacture; a connector tube with couplings at each end and a one way check valve. The interface may be a flat plastic disc or rectangle with a hole for gluing the tube into, and may have a grooved surface for facilitating air flow. The interface may be glued or otherwise sealed to an air-tight outer covering which seals the entire panel to retain the vacuum.

The disclosed vacuum insulation panel construction may comprise an interior rigid, porous support structure, such as a porous paper honeycomb core, strengthened on its broad top and bottom surfaces with reinforcing layers such as cardboard, and a layer of flexible air-tight material such as a plastic material enclosing the panel to seal in the vacuum. The honeycomb core, and cardboard outer shell may provide strength to resist collapse of the panel under atmospheric pressure once the vacuum is applied. The layer of porous material may facilitate air evacuation.

One aspect of the invention provides that the the interface part of the vacuum pump connector assembly may be a flat plastic disc or rectangle with means such as a hole or tube for securing the end of a connector tube. The interface may rest on the porous layer, under the impermeable outer layer. The vacuum pump may be part of the permanent installation, and can be set to activate at regular intervals.

According to a further aspect there is provided a system for providing adjustable insulative resistance in a building envelope which comprises: i) a plurality of vacuum insulation panels installed in the building envelope and comprising airflow communication between selected ones of the vacuum insulation panels; ii) a vacuum pump for connection to vacuum pump connector assemblies of the vacuum insulation panels to thereby increase or decrease the amount of vacuum in said vacuum insulation panels; and iii) means for controlling the activation of the vacuum pump to adjust said insulative resistance of said building envelope. The system may control the activation of the vacuum pump to adjust the insulative resistance of the building envelope in response to digital inputs provided by a programmable digital processor in conjunction with one or more thermostats, data including the time of day and day of the year, or current weather conditions such as rain, wind and humidity, or data from one or more photocells.

According to a further aspect, the plurality of vacuum insulation panels in the system may be sub-divided into a number of subsets of the vacuum insulation panels, each subset being commonly and independently connected to the vacuum pump whereby the insulative resistance of each subset is independently controlled to adjust its insulative resistance. Each subset in turn may be sub-divided into further subsets of vacuum insulation panels.

According to a further aspect, there is provided a method of managing the heating and cooling of a building by using the foregoing system, by selecting a target temperature for the interior of said building, programming the programmable digital processor to adjust the insulative resistance of each subset of the vacuum insulation panels independently based on given digital inputs; and using the programmable digital processor to continuously adjusting the insulative resistance of each said subset of the vacuum insulation panels independently based on the digital inputs by selectively activating the vacuum pump to adjust the insulative resistance of each subset of the vacuum insulation panels.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is partial cross-sectional view of an embodiment of a vacuum insulation panel taken along lines A-A of FIG. 3.

FIG. 2 is a bottom plan view of an embodiment of an interface for a vacuum pump assembly for the vacuum insulation panel shown in FIG. 3.

FIG. 3 is a perspective view partially cut away for illustration of an embodiment of a vacuum insulation panel.

FIG. 4 is a front view of an embodiment of a connector for the vacuum insulation panel shown in FIG. 3.

FIG. 5 is partial cross-sectional view of a second embodiment of a vacuum insulation panel taken along lines B-B of FIG. 9, in mirror image and partially cut away.

FIG. 6 is a top plan view of a second embodiment of an interface for a vacuum pump assembly for the vacuum insulation panel as shown in FIG. 5.

FIG. 7 is a perspective view of the interface for a vacuum pump assembly shown in FIG. 6.

FIG. 8 is a perspective cross-sectional view of the interface for a vacuum pump assembly shown in FIG. 6 taken along lines B-B of FIG. 9.

FIG. 9 is a perspective view partially cut away for illustration of the vacuum insulation panel as shown in FIG. 5.

FIG. 10 is a perspective view of a partially constructed wall incorporating a number of vacuum insulation panels as shown in FIGS. 5 and 9.

FIG. 11 is cross-sectional view in perspective of a partially constructed wall taken along lines C-C of FIG. 10.

FIG. 12 is a schematic drawing illustrating a building insulation zone system according to the invention.

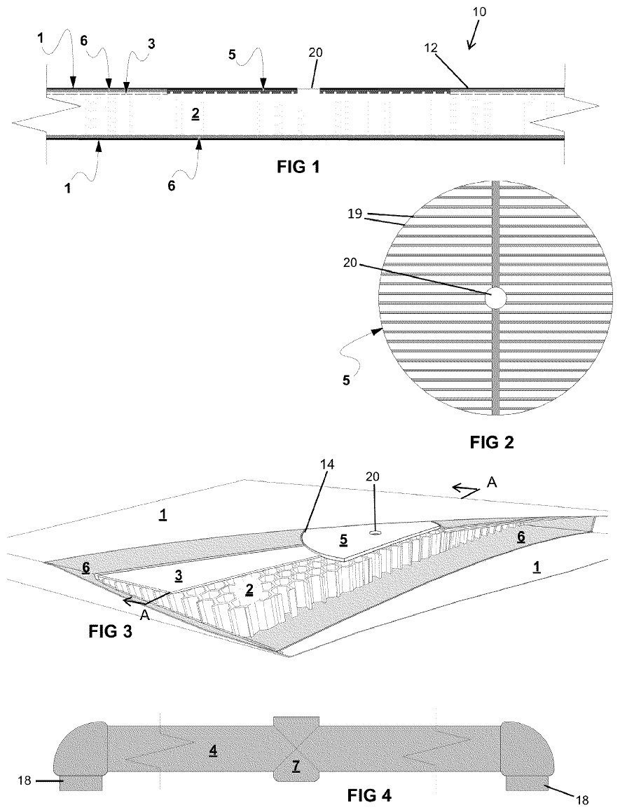

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The vacuum insulation panel 10 shown in FIG. 1 comprises vacuum panel 12 and a vacuum pump connector assembly. The purpose of the panel 12 is to contain the vacuum within a structure. Panel 12 can be installed in the walls and ceilings of residential or commercial buildings or anywhere insulation/sound proofing is required. Panel 12 may be made of the following components:
A. air-tight outer covering 1 which is impermeable to air and sealed on all four sides and to the outer surface of interface 5.
B. core 2 of paper honeycomb or other light strong material which creates the interior volume for the vacuum, and can preferably maintain that interior volume under at least about one atmosphere of compression.
C. optional porous layer 3 to facilitate the flow of air out of the interior of panel 12 during charging/recharging of the vacuum, located directly under the interface 5.
D. strength layer 6 made of cardboard or other inexpensive, strong material, which covers the sides as well as top and bottom of panel 12 to prevent collapse of panel 12. It is generally air-tight but may have opening 14 to receive interface 5 which enables air to flow out of the core 2, through the porous layer 3 and then through hole 20.

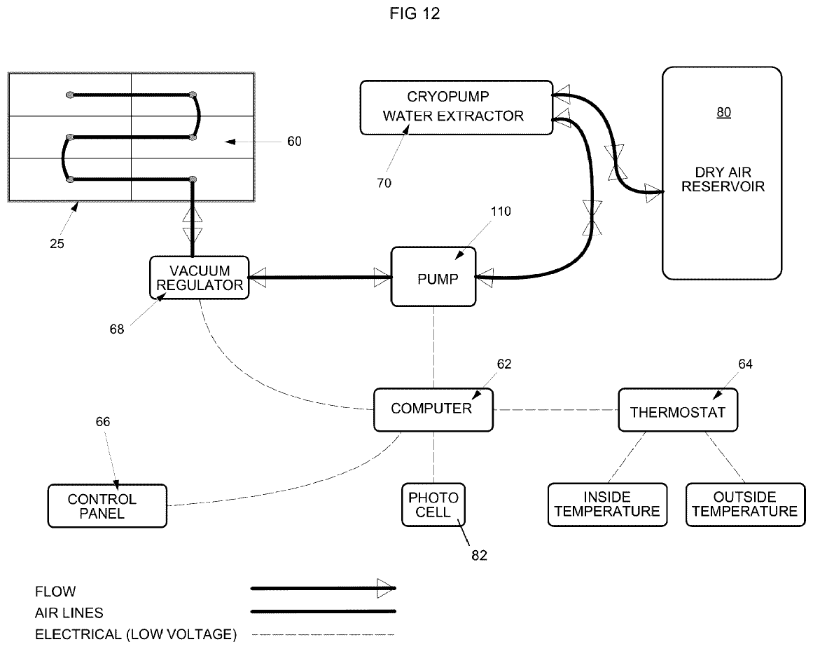

The connector assembly connects a panel 12 to the vacuum pump 110 (FIG. 12) either directly or in series or parallel with other panels 12. The connector assembly may be made of the following components:
A. tube 4, preferably made of flexible plastic that can preferably withstand at least one atmosphere of pressure;
B. interface 5 preferably made of a rigid material such as a hard plastic with a precision hole 20 for insertion of the end 18 of tube 4, or fittings that will connect to the end 18 of tube 4. The bottom surface of interface 5 may be grooved with grooves 19 to facilitate air flow. It is permanently sealed by heat or glue to the outer covering 1, at the time of manufacture and glued to the end 18 of tube 4 at the time of final installation.
C. one-way check valve 7 which will slow the vacuum loss between panels 12 in the event of a leak.

Interface 5 may be a flat disc or rectangle with the precision hole 20 in the center. It allows air to be removed from the core 2 and the precision hole 20 in the center will receive the glue-in tube end 18. Interface 5 may be installed in core 2 under the outer covering 1 and on top of the porous layer 3. It will be installed in the panel at the time of manufacture. There may be two or more interfaces 5 installed in each panel 12 during manufacture, for example one on each top and bottom side of core 2 to facilitate connecting each panel 12 to the panels above and below it. Alternatively only one interface 5 per panel 12 may be installed, with “T” fittings outside the panel to allow connection to other panels.

One or more connecting tubes 4 may be supplied with each panel depending on the number of interfaces 5 per panel. They may be constructed of flexible plastic, with two right angle ends 18 each of which can be glued into holes 20 of interfaces 5 of adjoining panels 12 after the panels 12 are installed in a wall of a frame structure, for example. The process of securing the ends 18 of tubes 4 to the holes 20 of interface 5 will form a hole in the outer covering 1 corresponding to hole 20 of interface 5 or such hole in the outer covering 1 can be made prior to securing the tubes 4 to interface 5, such as at the time of manufacture. Tubes 4 may also be T-shaped or X-shaped or form other configurations depending on the arrangement of panels, and one or more tubes 4 may have a direct or indirect connection to the vacuum pump 110 (FIG. 11). Check valve 7 may form part of the connecting tube 4 to allow air to flow only one way, namely out of the panel 12 when the vacuum pump (not shown) is activated, but not flow back in when the pump is off. It may reduce vacuum loss in the walls and ceiling in the event of damage to one panel. Alternatively the check valve 7 may form a separate element in the connections between panels 12 and/or the vacuum pump. Tube 4 may have a ⅜ inch outside diameter with all fittings and the one-way check valve dimensioned accordingly.

As shown in FIG. 3, panel 12 may comprise a paper honeycomb inner core 2 covered by a thin porous layer 3 on top of core 2, and completely wrapped in or covered by an impermeable outer covering 1. The outer covering 1 may be sealed in a non-vacuum environment during manufacture, with the vacuum pump connector interface 5 in place. For example a shrink wrap process may be used. The paper core 2 may be provided a frame of cardboard material, or wood for rigidity. While in general when the air is evacuated from the core 2 it should not collapse in any direction, a rigid frame (not shown) may be provided for core 2 to prevent lateral or transverse flexion. Instead of or in addition to providing the porous layer 3, flow of air between cells of the honeycomb during air evacuation may be achieved by providing holes in the walls of the honeycomb core 2 between adjacent cells of the honeycomb. Core 2, and hence the panel 12 as a whole, may be on the order of 1 to 4 inches in thickness, with a preferred thickness of 1 to 2 inches for standard climates. Porous layer 3 may be an air-permeable open cell polyurethane foam with a thickness on the order of 1/32 inch. Cardboard strength layer 6 preferably has a thickness of at least 1/16 inches. The air-impermeable outer covering layer 1 is preferably a plastic polymer film with a thickness of 0.006 to 0.0012 inches.

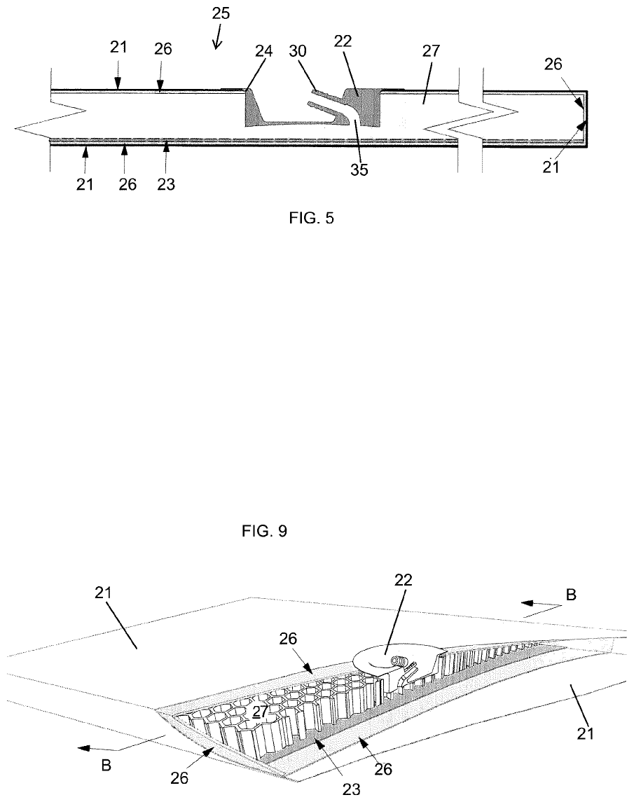

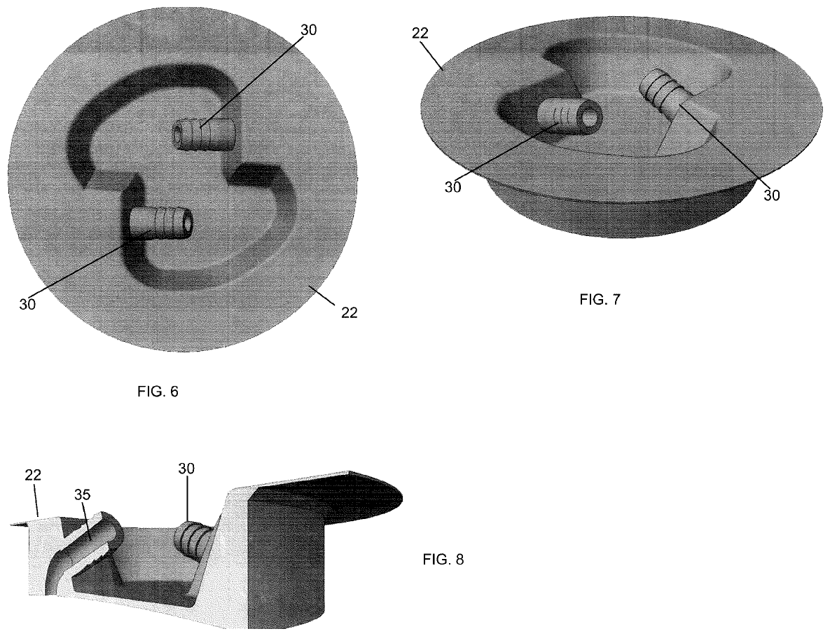

FIG. 5-11 disclose a second embodiment of the vacuum panels for use in the disclosed insulation system. Vacuum insulation panel 25 shown in FIG. 5 comprises an air-tight outer covering 21 which is impermeable to air and sealed on all four sides and to the interface 22. Core 27 in FIG. 5 may be of paper honeycomb or other light strong material which creates the interior volume for the vacuum, and can preferably maintain that interior volume under at least one atmosphere of compression. Optional porous layer 23 to facilitate the flow of air out of the interior of panel 25 during charging/recharging of the vacuum, is located under the core 27 on the side of the panel opposite interface 22. Strength layer 26 made of cardboard or other inexpensive, strong material, covers the sides as well as top and bottom of panel 25 to prevent collapse of panel 25 when air is pumped from the panel. It is generally air-tight but has opening 24 to receive interface 22 which enables air to flow out of the core 27, through connectors 30.

The connector assembly connects a panel 12/25 to the vacuum pump 110 (FIG. 12) either directly or in series or parallel with other panels 12/25. The connector assembly in the embodiment shown in FIGS. 5-11 may be made of the following components: i) flexible vacuum tubing 34, preferably made of flexible plastic that can preferably withstand at least one atmosphere of pressure; ii) interface 22 preferably made of a rigid material such as a hard plastic with two connectors 30 to receive an end of tubing 34, or fittings that will connect to the end 18 of tube 4. One-way check valves are not required in this embodiment.

Interface 22 in the second embodiment provides two connectors 30 for connecting to tubing 34 to the vacuum pump 110 (FIG. 12) either directly or in series or parallel with other panels 25. Connectors 34 each have a central passage 35 communicating with the interior core 27 of the panel, allowing air to be removed from the core 27. Interface 22 may be installed into core 27 in this embodiment on top of the outer covering 21. It will be installed in the panel at the time of manufacture. Providing two connectors 30 facilitates connecting each panel 25 in series to the adjacent panels. The configuration of connectors 30 is such that the upper face of interface 22 is in essentially the same plane as outer covering 21, permitting the panels to be stacked flat. For a panel which is situated as the last panel in a connected series, one of the connectors 30 may be capped with a removable cap (not shown).

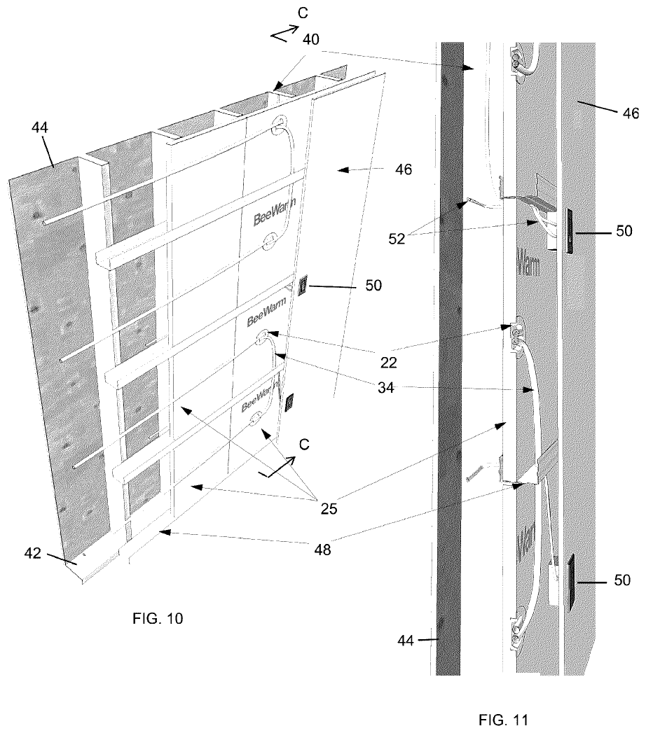

FIGS. 10 and 11 illustrate the vacuum panels according to the second embodiment shown in FIG. 5 installed in a partially constructed exterior wall of a frame building having studs 40 extending upwardly from bottom wall plate 42 and having exterior sheathing 44 and interior drywall panels 46. Panels 25 may be installed across the interior face of the studs 40 to reduce thermal bridging. Panels 25 may sit in and be held in place by lightweight, strong U-shaped panel-mounting channels 48 which will be attached to the inside edges of the studs 40 or wall plates 42, with drywall panels 46 secured to the interior edge of channels 48. Channels 48 may have a horizontal dimension considerably wider than panels 25, for example 2 inches deep for panels 25 having a 1 inch thickness, so that panels 25 may be installed closest to studs 40 leaving a space between the panels 25 and drywall 46 for protection of panels 25 from screws and nails installed in the drywall. The interior vertical extension of channels 48 may receive the drywall/gyproc screws whereby the drywall 46 or other interior wall finishes can be attached directly to the channels 48.

As shown in FIGS. 10 and 11, according to this arrangement the vacuum tubing extends in the space formed between panels 25 and drywall 46 and may connect vertically adjacent panels 25 through apertures in the horizontal element of channels 48. Electrical outlets 50 may be installed in the interior drywall panels 46 with connected electrical wires 52 similarly routed from outlet 50 through the horizontal or vertical spaces between panels 25 and running in the usual way through and between studs 40.

Alternatively or in addition panels 25 may be installed on the exterior of studs 40 by installing channels 48 on the outside edges of studs 40 and wall plates 42 of the wall, with the exterior sheathing 44 being secured to the exterior vertical element of the channels 48. In this configuration as in the previous configuration, the vacuum tubing lines would be arranged to be accessible from inside the building.

As shown in FIGS. 10-12, panels 25 may be connected in series in one or more groups by tubing 34 to the vacuum pump 110. In this way a number of separately controlled heating or cooling zones 60 can be created in a building. The ‘R’ value (resistance to conductive heat flow) of each vacuum panel's insulation is proportional to the level of the vacuum in each panel. The higher the vacuum, the higher is the R value. The level of vacuum can be adjusted in every panel 25 in a zone 60, from zero to one atmosphere. Thus every panel 25 will have a variable R value as the level of vacuum in the panel is varied. For a panel one-inch thick, that may be from about 5 to 50. In very extreme locations, two or three panels 25 can be installed on top of each other, or single panels that are 3 or 4 inches thick, for R values as high as 150, or as low as 15.

The system for regulating the temperature (or level of sound insulation) using the vacuum insulation panels disclosed above is shown in FIG. 12. A computer 62 or other information processing device, for example a programmable digital processor such as a programmable logic controller or programmable thermostat, controls a vacuum regulator 68 which controls and/or measures the level of vacuum in the air flow into the regulator, and which may simply be an open and close valve, and a vacuum pump 110. The computer 62 receives signals from one or more thermostats 64 which measure the temperature inside and outside the building at the various zones 60. Each zone 60 will have a thermostat 64 at the corresponding indoor location to measure and regulate the indoor temperature. It will react to the temperature measured by a thermostat 64 outside the building envelope (“outside temperature”) and the set desired inside temperature. A photocell 82 may be used to detect changes in light conditions such as the rising and setting of the sun and communicate that to computer 62.

The provision of a plurality of zones 60 allows the system to account for and utilize the building's orientation towards or away from the sun, in conjunction with time of day, inside and outside temperature and inputs from photocell 82. Preferably every exterior surface of a building is provided with panels 25, either inside the walls or inside the exterior cladding, but each building will have different zones 60 depending on the orientation and situation of the building. Typically south facing and north facing attic walls will define one or more different zones. North facing and south facing walls may be one or more separate zones 60. East and west facing walls will be one or more separate zones 60. North and south cellar walls will be one or more zones 60. It will be possible to both capture and expel hot and cold air from every portion of a building, as needed, in conjunction with and at the direction of the computer 62.

For example, on a sunny, cold day in the winter in the northern hemisphere it would be possible to have 100% insulation on the north side attic and main walls, and south facing cellar walls while having 70% insulation on south facing walls and 10% insulation on south facing attic walls. When the sun sets, all walls would return to 100% insulation, and trapped heat in the attic could be blown around inside the building. Photocell 82 may signal computer 62 when the sun rises, reducing delay time to drop the insulation R value on the south facing surfaces, and when the sun sets, delay time will be reduced for raising the insulation. By contrast, on a sunny, hot day in the summer, it would be possible to have 100% insulation on all walls during the day to keep heat out, and at night 10% insulation on all walls to allow heat to escape, while convection created by escaping heat, and perhaps open skylights of plenums would draw in cool air from the cellar, earth tubes or vents near the floor on the main level. The photocell 82 will reduce delay time for the dropping the insulation R value at night and raising the insulation at dawn.

Within a single building only one pump 110, one cryopump 70 or other water extractor, one dry air reservoir (DAR) 80, one photocell 82, one computer 62 and one control panel 66 may be required. For each zone 60, separate vacuum regulators, thermometers and thermostats may be required. Zones 60 can in turn be subdivided into sub-zones, of four panels maximum as an example, with each panel 25 in a sub-zone separately connected to the pump 110 through a header. This arrangement will allow easy identification and repair of leaking panels and allow data concerning each panel to be displayed on the control panel 66.

The computer 62 may receive input from, and may display output on, a control panel 66 having a graphical user display. Control panel will permit the user to establish and save system settings or override same. Dry air flows in the system between a source of air 80, preferably a dry air reservoir which could be any source including the atmosphere, and panels 25. Upon sensing from thermostat 64 or control panel 66 that a higher degree of vacuum is required in zone 60, the computer activates vacuum regulator 68 and vacuum pump 110 to extract air from the panels 25 in zone 60. Air is then drawn by vacuum pump 110 out of panels 25 until the pre-selected degree of vacuum is achieved. Conversely if the computer 62 determines that a lower degree of vacuum is required in panels 25 (for example where the interior of the building is too hot), the computer 62 activates vacuum regulator 68 and vacuum pump 110 to pump air into the panels 25 in zone 60. Such adjustments can occur on an hourly or daily basis, taking advantage of natural heat and cold, and avoiding thermal lag, in some cases, and capitalizing on thermal lag, in other cases. In this way the building temperature can be regulated more easily, with fewer heating, cooling or ventilation inputs, and adapting to conditions in different zones due to, for example wind, freezing rain, ice, direct sunlight and other extremes. The thermostat and computer may therefore provide ongoing adjustment in the vacuum level in panels 25 to cause the vacuum pump 110 to evacuate the panels to increase R value and re-pressurize the panels to decrease R value based on digital inputs including the time of day and day of the year, or current weather conditions such as rain, wind and humidity. If required, the air coming and going from the panels 25 can be held in a dry air reservoir (DAR) 80 to reduce the amount of water vapor in the panels. The pump 110 can pressurize the DAR while it vents the panels 25 to raise R value, and draw dry air from DAR 80 to lower the R value. Alternatively, air going back into the panels 12/25 can be passed through the cryopump 70 which will freeze the water out of the air stream.

The computer 62 may as part of the disclosed system control other functions in the building in question. As the R values fall or rise, high efficiency window coverings can be opened or closed at the direction of the computer. Roof top heat exhaust such as plenums or skylights likewise can be opened or closed. Cold air can be introduced into the building from a basement, earth tubes or elsewhere through vents, windows or plenums along with a reduction in R value after a hot day, to accelerate evening cooling. Heat will flow out through the walls and ceiling, instead of being trapped by high R value insulation. In the morning, or during the night, R value can be increased in specific zones to preserve the interior temperature, and avoid the need to heat of the building. Vents, windows or plenums can be closed. In a cold climate, R values will be increased in the afternoon in anticipation of the lower temperatures at night, rather than increased heating in reaction to the temperature change when it occurs. In the morning, as the sun warms the sun-facing walls and roof, the R value in those surfaces can be reduced to let the heat in. Adjustable computer regulated vents can bring in air heated in exterior glass enclosed spaces, or in the attic, where it can be stored.

The disclosed vacuum insulation panels 12/25 can be produced for the same cost or less than fiberglass batts for an equivalent area with R40, will require a 4 inch deep space, rather than a 6 inch deep space, and will provide more R value with one inch, than 14 inches of fiberglass batt. Heating and cooling costs are thus significantly reduced with more R value in the walls and significant reductions in construction costs, both labor and materials will be realized. Studs can be 2×3 or 2×4 rather than 2×6 or 2×12. Less labor will be required to build ceiling supports, and less wood will be necessary to support the panels 12/25, which are light, weighing for example less than 2 pounds for a 30×48 inch panel, compared to mineral wool which can weigh up to 230 kg/cubic meter. Fiberglass provides R 3.5 per inch, while the disclosed panels may provide R 50 per inch.

Panels 12/25 may alternatively be compressed slightly between studs of a frame structure before the air is evacuated, or they could be made smaller than the space between studs, with an external edge made of fiberglass or foam to compress between studs. Such external edge may also totally seal the wall. Alternatively, the panels may be made bigger and may be glued into the wall with sound absorbing caulking compound. Panels may be installed between studs on standard 16 or 24 inch centers. Small holes may be drilled in the studs, such as holes for electrical wires and the connector tubes 4 from each panel may be connected in series and end at the vacuum pump. For other applications, such as retrofitting a wall or a soundproof studio in a building, large panels can be used. The panels can be glued directly onto a finished outer skin, such as door skin. Wood edges can be glued onto the panel for attachment by screws, or strips of plastic can be glued to the outside of the panel to use as hangers. Limits to size will be determined by the limitations of shipping and handling.

The disclosed embodiments exhibit a number of efficiencies. Negligible moisture should enter the sealed panels 12/25. Moisture in fiberglass or mineral wool products however can reduce efficiency by 50%. No leakage of the vacuum can reduce the R value, since vacuum in the panel 12/25 can be re-charged at any time by activating a vacuum pump. Foil reflective material may also be attached directly to the panel 12/25 boosting the R value by as much as 20 units. The vacuum pump 110 may be part of the permanent installation, and can be set to activate at regular intervals.

The described recharge feature will allow a less costly impermeable outer covering, lower manufacturing costs, lower damage rate post-manufacture, better consumer confidence and the ability to repair the panel without complete removal from the wall. If a nail is accidentally driven through the drywall, or other finished wall covering puncturing the panel, a small section of the finished covering can be cut out, and a patch applied to the leaking panel, and the vacuum charge restored. Additionally, the panels 12/25 can be manufactured in any standard size and custom sizes from readily available paper honeycomb stock, cardboard, porous sheet material and plastic outer covering. Custom shapes can be created by plastic or metal frames, covered with the vacuum sealing outer covering, connected with a vacuum pump. Panels 12/25 may be cheap, repairable, rechargeable, light and easy to install, and easy to transport. The connections between panels 12/25 and to the rest of the system may be kept simple, and require no special tools or training. Similarly attaching the panels 12/25 to the wall is simple and requires no special tools or training. All of the components of the system other than the panels 12/25 are off the shelf and the component materials of the panels 12/25 are off the shelf. Preferably no toxic materials need be found in the panels 12/25, unlike photovoltaic panels, so decommissioning may be hazard free. The panels 12/25 should be long-lasting since there are no moving parts, with nothing to wear out and no energy inputs.

The system is preferably fully automatic. Once the settings are confirmed, heating and cooling will be carried out with reduced energy consumption. Each indoor zone will have a thermostat to measure and regulate the temperature. It will react to: i) temperature outside the insulation panels or building envelope (“outside temperature”); and ii) desired inside temperature. Each zone 60 may have a vacuum valve that will be opened and closed by the computer 62 as directed by the thermostat 64, depending on the inside and outside temperature. The thermostat 64 and computer 62 will respond to the seasons, day time warmth and night time cold, and the rising and setting of the sun as directed by the photocell 82. Micro adjustments in vacuum level may smooth the R transition. The vacuum pump 110 will be controlled by the computer 62 as well, evacuating the panels 12/25 to increase R value and re-pressurizing the panels 12/25 to decrease R value. If required, the air coming and going from the panels 12/25 can be held in the dry air reservoir (DAR) 80 to reduce the amount of water vapor in the panels. The main pump can pressurize the DAR while it vents the panels to raise R value, and draw dry air from it to lower the R value.

As disclosed, the R value in the walls and ceiling may be increased or decreased to achieve the target internal temperatures in different parts of the building as the exterior temperature changes, with inputs of heat or cooling to keep the building at the desired temperature. Insulation and ventilation values in a building will be presented on the control panel screen displayed in the home. It will allow system overrides, and it will market the system to the homeowners' guests and allow remote access to the system.

Further, electrically driven heating and cooling can be reduced or eliminated. Passive solar heat collection through Trombe Walls or other methods can be reduced or eliminated. Thermal savings in window coverings and other items can be enhanced by co-ordination with the variable insulation system as herein described. Naturally available heat and cold will be utilized in the simplest way possible, reducing the energy costs to the building.

Ice chests and other small cold/heat containers can be charged with vacuum before use by utilizing the disclosed panels. Panel shipping is less risky, because the vacuum charge occurs at the time of installation. No special tools or holders are needed to place the panels in between studs, or in other locations. In a construction setting, the panels may be installed between studs as fiberglass batts are presently, and if necessary tape can be used to hold the panels in place before the drywall goes on.

Heat/cold insulation uses for the disclosed panels include: residential/commercial construction, appliances, ‘tiny homes’ (trailers, recreational vehicles and motorhomes which move and have a constantly changing orientation to the sun), shipping containers and other applications requiring a thin wall, high R value insulation. Sound proofing applications include: residential and commercial construction, commercial/industrial ‘sound curtains,’ or home/commercial music studios. This product may be useful for retrofitting existing buildings to reduce noise between rooms or apartments and ‘street’ noise. In a high performance building, which is sealed to avoid heat loss or cold loss so that the air becomes stale and must be replaced through heat exchangers, the need for heat exchangers can be reduced. Further, electrically driven heating and cooling can be reduced or eliminated. Passive solar heat collection through Trombe Walls or other methods can be reduced or eliminated. Thermal savings in window coverings and other items can be enhanced by co-ordination with the disclosed variable insulation system. Naturally available heat and cold will be utilized in the simplest way possible, reducing the energy costs to the building.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

1. A vacuum insulation panel comprising;
a. first and second opposed faces connected by opposed sides joining said opposed faces to form an interior space of said insulation panel;
b. a generally rigid reinforcing core extending between said first and second opposed faces in said interior of said panel to maintain a hollow space in said interior of said panel after extraction of air from said interior of said panel and to permit the extraction of air from said hollow interior space;
wherein each of said opposed faces comprises a non-porous layer external to said rigid reinforcing core and extending across each said opposed face between said opposed sides of said panel;
c. an outer layer of air-impervious flexible material sealingly enclosing said panel to retain a vacuum in said hollow interior space; and
d. a vacuum pump connector assembly for charging of the vacuum in said panel prior to, at the time of, or after installation of said insulation panel, by activation of a vacuum pump, said vacuum pump connector assembly comprising a connection interface mounted in at least one of said faces comprising a connection element adapted to receive one end of a connector having a first end for securing to and communicating with said interface and a second end for connection external to said panel, whereby air may be extracted from or introduced into the interior of said panel, said connection element forming an aperture communicating with said hollow interior space in said panel for sealingly providing an air passageway from the exterior of said panel to the hollow interior of said panel, said vacuum pump connector assembly comprising a rigid, generally planar outer edge surrounding said connector element whereby said generally planar outer edge in combination with said outer air-impervious layer sealingly secures said connector assembly to said at least one of said faces.

2. The vacuum insulation panel of claim 1 wherein said reinforcing core comprises a honeycomb structure.

3. The vacuum insulation panel of claim 2 wherein said non-porous layer comprises a semi-rigid cardboard layer sufficiently rigid to provide strength in combination with said reinforcing core to resist collapse of said panel after removal of air from the interior of said panel.

4. (canceled)

5. (canceled)

6. The system of claim 19 wherein said means for controlling the activation of said vacuum pump to adjust said insulative resistance of said selected ones of said plurality of insulation panels comprises programmable digital processing means for processing digital signals.

7. The system of claim 6 further comprising a thermostat for measuring temperature at a selected location within or outside said building envelope to provide a digital signal to said programmable digital processing means to control the activation of said vacuum pump to adjust said insulative resistance of said selected ones of said plurality of insulation panels in response thereto.

8. (canceled)

9. (canceled)

10. (canceled)

11. The system of claim 22 wherein said plurality of vacuum insulation panels comprise a plurality of sub-subsets of said vacuum insulation panels within each said subset of said vacuum insulation panels, each said sub-subset of said vacuum insulation panels being commonly and independently connected to said vacuum pump whereby the insulative resistance of each said sub-subset is independently controlled by said means for controlling the activation of said vacuum pump to adjust said insulative resistance of said sub-subset of said vacuum insulation panels.

12. (canceled)

13. The system of claim 23 wherein said building envelope comprises vertical studs and said plurality of vacuum insulation panels is secured to interior surfaces of said vertical studs.

14. The system of claim 23 wherein said plurality of vacuum insulation panels is secured to interior surfaces of said building envelope by means of a plurality of horizontally extending supports secured to said interior surfaces of said building envelope, said horizontally extending supports having an upper surface for supporting a lower edge of a vacuum insulation panel.

15. The system of claim 14 wherein said horizontally extending supports secured to said interior surfaces of said building envelope are adapted to have drywall panels securely attached to a vertical surface of said horizontally extending supports.

16. (canceled)

17. The method of claim 24 wherein at least one of said plurality of subsets of said vacuum insulation panels is divided into a further plurality of sub-subsets of said vacuum insulation panels; and comprising the further steps of:
v) programming said programmable digital processing means to adjust the insulative resistance of each said further sub-subsets of said vacuum insulation panels independently based on said digital inputs; and
vi) said programmable digital processing means continuously adjusting the insulative resistance of each said further sub-subsets of said vacuum insulation panels independently based on said digital inputs by selectively activating said vacuum pump to adjust said insulative resistance of each said further sub-subset of said vacuum insulation panels.

18. The vacuum insulation panel of claim 1 further comprising a layer of porous material between said non-porous layer and said reinforcing core to facilitate air evacuation from said hollow interior space whereby said insulative resistance of said vacuum insulation panel is adjusted by increasing or decreasing the vacuum in said vacuum insulation panel.

19. A system for providing adjustable insulative resistance in a building envelope, said system comprising:
i) a plurality of vacuum insulation panels as claimed in claim 1 installed in said building envelope and a plurality of connectors to provide airflow communication between selected ones of said vacuum insulation panels;
ii) means for supporting a continuous array of said panels against an interior surface of said building envelope;
iii) a vacuum pump for connection to said vacuum insulation panels to thereby increase or decrease the amount of vacuum in said vacuum insulation panels; and
iv) means for controlling the activation of said vacuum pump to adjust said insulative resistance of said building envelope by adjusting the amount of vacuum in selected ones of said plurality of insulation panels.

20. The system of claim 6 wherein said digital signals represent the time of day, day of the year, or current weather conditions at the location of said building envelope.

21. The system of claim 6 wherein said digital signals include the output of a photocell.

22. The system of claim 19 wherein said plurality of vacuum insulation panels comprise a plurality of subsets of said vacuum insulation panels, each said subset of said vacuum insulation panels being commonly and independently connected to said vacuum pump whereby the insulative resistance of each said subset is independently controlled by said means for controlling the activation of said vacuum pump to adjust said insulative resistance of said subset of said vacuum insulation panels.

23. The system of claim 19 wherein said plurality of vacuum insulation panels is removably secured to an interior surface of said building envelope in a continuous array for replacement or repair of one or more of said plurality of vacuum insulation panels.

24. A method of managing the heating and cooling of a building by carrying out the following steps:
i) providing the system of claim 22 comprising a plurality of subsets of said vacuum insulation panels;
v) selecting a target temperature for the interior of said building;
vi) programming said programmable digital processing means to adjust the insulative resistance of each said subset of said vacuum insulation panels independently based on said digital inputs; and
vii) said programmable digital processing means continuously adjusting the insulative resistance of each said subset of said vacuum insulation panels independently based on said digital inputs by selectively activating said vacuum pump to adjust said insulative resistance of each said subset of said vacuum insulation panels.
